(19) United States
(12) Patent Application Publication
(10) Pub. No.: US 2020/0316852 A1
(43) Pub. Date: Oct. 8, 2020

(54) METHOD FOR MANUFACTURING A SKIN OF VARIABLE PROPERTY

(71) Applicant: FAURECIA INTERIEUR INDUSTRIE, Manterre (FR)

(72) Inventors: Solenne RUITENBURG, SAINT GERMAIN EN LAYE (FR); Geoffroy TOPART, BEAUVAIS (FR)

(21) Appl. No.: 16/840,048

(22) Filed: Apr. 3, 2020

(30) Foreign Application Priority Data
Apr. 5, 2019 (FR) 19 03685

(51) Int. Cl. B29C 64/118; B33Y 10/00; B33Y 80/00

(52) U.S. Cl. CPC B29C 64/118; B33Y 10/00; B29L 2031/3041; B29K 2995/0026; B29K 2995/0025; B33Y 80/00

(57) ABSTRACT

A method for manufacturing a skin from a plastic material. The method includes the following steps: producing a first part of the skin having a property according to a first level, producing a second part of the skin extending the first part and having the property at the first level on a first edge in contact with the first part and a second level on a second edge in contact with a third part of the skin extending the second part, and producing the third part of the skin having the property at the second level, the production steps being carried out using additive technology, such as 3D printing. Also provided is a skin obtained by such a method.

This application claims the benefit of French Patent Application No. FR 19 03685 filed on Apr. 5, 2019, which is hereby incorporated by reference.

### TECHNICAL FIELD

The invention relates to the field of manufacturing an esthetic finishing skin for a surface, as used in the automotive or building fields.

### BACKGROUND

It is known to produce a dashboard in a structure, generally more rigid, and to cover it with a skin producing a finish. This skin, which is generally thin, is more flexible. It makes it possible to introduce esthetic effects (colors, sheens, etc.), haptics (smoothness, velvety feel, softness, grain, foam, etc.) or textures participating in both (appearance of wood, leather, snakeskin, etc.).

Depending on any equipment items that may be integrated into the dashboard (lighted indicator, display, screen, etc.), it may be necessary to change at least one property of the skin. Thus, in the absence of equipment, a skin is advantageously opaque so as to hide the underlying structure. On the contrary, in line with a display, a skin is advantageously transparent. Likewise, in line with a screen, a skin is advantageously rigid so as to offer said screen some protection, whereas it is preferably flexible elsewhere so as to marry the shapes, which are often curved, of the structure.

Currently, such a property change necessarily causes a production in two different parts. A joint then inevitably appears at the junction between the two parts and is damaging to the esthetics of the whole.

A solution is therefore sought making it possible not to encounter this drawback.

### SUMMARY

A goal of the invention is directed to producing the whole in a single part gradually varying the composition of the material so as to have a property variation within a same skin.

To that end, the invention relates to a method for manufacturing a skin from a plastic material, comprising the following steps: producing a first part of the skin having a property according to a first level, producing a second part of the skin extending the first part and having said property at the first level on a first edge in contact with the first part and a second level on a second edge in contact with a third part of the skin extending the second part, and producing the third part of the skin having said at least one property at the second level, the production steps being carried out using additive technology, such as 3D printing.

Specific features or embodiments, usable alone or in combination, are:
said property evolves, in the second part, between the first edge and the second edge, preferably regularly,
said property comprises the hardness, the color, the transparency and/or the surface state,
the production of the first part uses a first supply filament having the property at the first level, the production of the third part uses a second supply filament having the property at the second level and the production of the second part alternatively uses the first supply filament and the second supply filament,
the alternation is produced by alternating a first head supplied with the first filament and a second head supplied with the second filament,
application to the production of a skin of a vehicle interior trim element,
application to the production of a dashboard skin,
the first part is substantially rectangular, the second part is positioned on either side around the first part and the third part is positioned on either side around the second part,
the first part is rigid and transparent, the third part is flexible and opaque and the second part has a gradient of at least one of the two properties.

The invention also relates to a skin made from plastic obtained by such a method.

### BRIEF DESCRIPTION OF THE DRAWINGS

The invention will be better understood upon reading the following description, provided solely as an example, and in reference to the appended figures, in which:

FIG. 1 shows an exemplary embodiment obtained by the invention, and

FIG. 2 shows a sectional view of the skin of the embodiment of FIG. 1.

### DETAILED DESCRIPTION

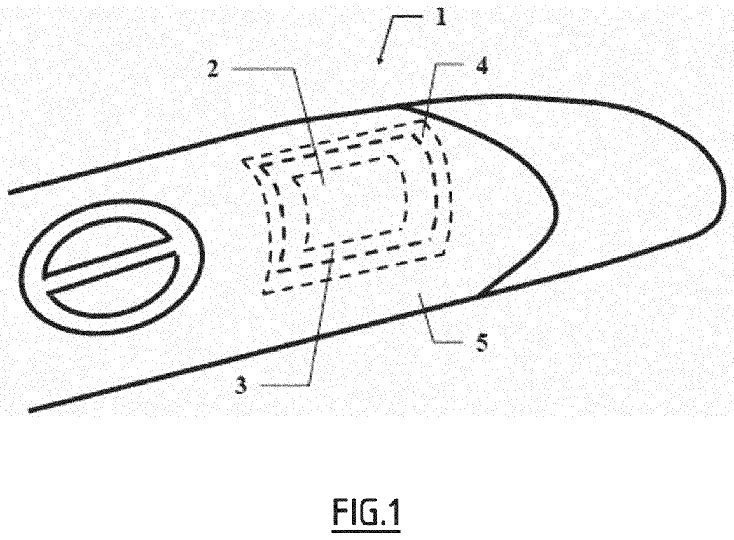

The invention relates to a method for manufacturing a skin 1 made from plastic. As illustrated in FIG. 1, such a skin 1 is for example able to be positioned on a structure of an interior vehicle trim element in order to cover it and form a visible upper finishing layer. The interior vehicle trim element is for example a dashboard, a door panel or a center console. The skin 1 is conventionally made from a plastic material, such as a thermoplastic like a polyvinyl chloride (PVC), a thermoplastic olefin (TPO), a thermoplastic polyurethane (TPU) or any other equivalent, and molded so as to cover all or part of said structure.

The aim is to produce such a skin 1 in a single piece. To that end, the skin 1 comprises a first part 2. In light of a property, this first part 2 has a first level. The skin 1 further comprises a third part 4 having, in light of the same property, a second level. The skin 1 further comprises a second part 3 adjoining the first part 2 by a first edge or contour and adjoining the third part 4 by a second edge or contour. This intermediate second part 3 has, in light of the same property, the first level on the first edge and the second level on the second edge. Thus, the second part provides, at each of the two edges or contours, a continuity of the property with the first part 2 and the third part 4.

The manufacturing method thus produces the skin 1 continuously, by producing: during a first step, the first part 2 according to the first level of the property, during a second step, the second part 3 by beginning according to the first level of the property for the first edge and finishing according to the second level of the property for the second edge, and, during a third step, the third part 4 according to the second level of the property. These various steps may or may not be done in order. It is also possible to perform part of a step, go to part of another step, before going back to finish another part of the first step, for example. The exact manufacturing sequence will be determined based on the desired product. Nonsequential production may be advantageous in that it makes it possible to avoid flaws.

The skin 1 obtained using the method is monobloc: it does not have any interruption in its structure.

Between the first edge and the second edge of the second part 3, said property evolves gradually from the first level to the second level. This evolution is preferably regular.

The considered property may be any property of the plastic material used to produce the skin 1. As an example, the property can be the hardness, the color, the transparency and/or the surface state.

When the property is the color, the first level may be a first shade, for example white, and the second level may be a second shade, for example black. In this case, the first part 2 is white, the third part 4 is black, and the second part 3 is white over its first edge shared with the first part 2 and black on its second edge shared with the third part 4. The second part 3 also has a gray gradient between its two edges.

When the property is the hardness, which for a plastic material is equivalent to its suppleness and/or flexibility, the first level can be a first hardness level, for example rigid, with a hardness indicative and illustrative of 95 shore and the second level can be a second hardness level, for example flexible, with a hardness indicative and illustrative of 40 shore. In this case, the first part 2 is rigid, the third part 4 is flexible, and the second part 3 is rigid over its first edge shared with the first part 2 and flexible on its second edge shared with the third part 4. The second part 3 also has a hardness gradient between its two edges. This is advantageous in that such a skin can thus comprise a rigid part (first part 2) able to protect an equipment item positioned below, a flexible part (third part 4) able to marry the various shapes of the dashboard, and an intermediate part (second part 3) having a transition that may or may not be gradual, in terms of hardness between the two parts 2, 4, and above all not having any cut or break between the two parts 2, 4.

When the property is the opaqueness, the first level may be a first level of opaqueness, for example transparent (0% opacity), and the second level may be a second level of opaqueness, for example opaque (100% opacity). In this case, the first part 2 is transparent, the third part 4 is opaque, and the second part 3 is transparent over its first edge shared with the first part 2 and opaque on its second edge shared with the third part 4. The second part 3 thus has a progressive opacity transition zone between its two edges, which can be abrupt or gradual, but above all the second part 3 ensures a continuity of the skin 1 that has no interruption or break between the two parts 2, 4. Such a skin 1 is advantageous in that it makes it possible to produce windows (first part 2) through which it is possible to see an equipment item located below the skin, masks (third part 4) hiding what is located below them, and still in a monobloc skin 1.

When the property is the surface state, the first level may be a first texture, for example smooth, and the second level may be a second texture, for example grooved or snakeskin or granular. In this case, the first part 2 is smooth, the third part 4 is granular, and the second part 3 is smooth over its first edge shared with the first part 2 and granular on its second edge shared with the third part 4. The second part 3 also has an abrupt or gradual variation of the granularity between its two edges. This is advantageous in that such a skin can thus comprise zones with different textures within a same monobloc skin 1, having no cut or break between the two parts 2, 4.

It is clear that it is possible to mix the different properties at leisure with or without spatial superposition.

In order to produce such a skin 1 and above all a property variation within a same skin 1, the production steps are advantageously carried out using additive technology, such as 3D printing. It is thus possible to vary the property by varying the material used to print as a function of the part of the skin 1 being printed. Thus by choosing a first material, having a property at the first level, it is possible to print the first part 2. By choosing a second material, having the same property at the second level, it is possible to print the third part 4.

It should be ensured that the first material and the second material are compatible so as to be able to mix with one another during a 3D printing process. It is therefore possible to mix the first material and the second material by varying their respective proportion to produce the second part 3. Thus, in order to print the second part 3 near the first edge, the method uses 100% of the first material and 0% of the second material, and to print the second part 3 near the second edge, the method uses 0% of the first material and 100% of the second material. Between the two edges, the printing of the second part 3 uses a variable proportion 100-X % of the first material and X % of the second material, with X varying from 0 to 100 between the two edges, according to a selected spatial evolution profile.

Several types of 3D printers exist. All of these types are usable to carry out the method. It is thus possible to distinguish between filament printers and free modeling printers without tools after melting of the material according to an Arburg Plastic Freeforming (AFP) method. The remainder of the description assumes, without restricting the scope of the invention, that a filament printer is used.

A 3D printer is typically supplied with material procured in the form of a filament spool, made from homogeneous material. A first supply filament having the property at the first level and a second supply filament having the property at the second level are advantageously used. The production of the first part 2 is therefore done conventionally by using the first supply filament and the production of the third part 3 is advantageously done conventionally by using the second supply filament.

The production of the second part 3 requires being able to mix the two materials so as to vary their respective proportions.

The mixing is done by alternating the two materials by using two printing heads. A first head is supplied with the first filament and a second head is supplied with the second filament. The mixing in a desired proportion is obtained by alternating the use of the heads during the material printing. The respective usage durations of each of the heads are determined as a function of the desired respective proportions for the two materials. Thus, near the first edge, short uses of the second material/second head intersect longer uses of the first material/first head so as to obtain a mixture comprising a high proportion of first material. On the contrary, near the second edge, long uses of the second material/second head are intersected by short uses of the first material/first head so as to obtain a mixture comprising a high proportion of second material. Between the two edges, the respective lengths of the uses change, the uses of first material become shorter as the uses of second material become longer.

Such a manufacturing method is advantageously used to produce a skin of an interior trim element. Such a manufacturing method is preferably used to produce a skin intended to cover a trim element incorporating an equipment item, for example a screen, the skin being intended to cover said equipment item at least partially, preferably in its entirety.

An exemplary application showing the advantages of the above-described embodiment will now be described in relation with FIG. 1.

The manufactured skin 1 is intended to cover a dashboard incorporating a screen shown by a rectangle in the center of the figure. The manufactured skin 1 is monobloc and covers at least part of the dashboard, including the screen. The skin 1 has a first part 2, in line with the screen, having a rigidity property in order to protect the surface of the screen, and at the same time a transparency property so that the screen can be seen. On the contrary, in a third part 4, the skin 1 is flexible so as to marry the curved shapes of the dashboard and opaque so as to hide the latter. In a second transitional part 3, positioned between the first part 2 and the third part 4, the hardness changes, preferably continuously, between the hardness of the first part 2 (rigid) and the hardness of the third part 4 (flexible). Likewise, the opacity changes, preferably continuously, between the opacity of the first part 2 (transparent) and the opacity of the third part 4 (opaque). The skin 1 produced by the method described herein advantageously makes it possible to produce a monobloc skin not having any break or demarcation at the limits of the screen.

Here, the two properties changing spatially in concert, a mixture of two materials can be used: a first rigid and transparent material and a second opaque and flexible material.

The skin 1 of FIG. 1 can also have a variable surface state property. Thus, advantageously, the first part 2 in line with the screen has the smoothest possible surface. On the contrary, a grain in the second part 3 can emphasize the contour of the screen and thus facilitate its location by touch. In this embodiment, the first part 2 is smooth and the third part 4 is textured. The second part 3 for example has a change of surface state, preferably regular, between the surface state of the first part 2 (smooth) and the surface state of the third part 4 (textured).

It appears that the arrangement of the first, second and third parts can be linear: 2, 3, 4, reproduced symmetrically: 4, 3, 2, 3, 4, or two-dimensional, as illustrated in FIG. 1: a central first part 2, a second part 3 surrounding the first part 2, and a third part 4 surrounding the second part 3.

The invention also relates to a skin 1 made from plastic obtained by the method described herein.

According to one preferred embodiment, the method is used to produce a part of the dashboard skin comprising the part covering the screen and a part covering the dashboard around the screen, but not the entire dashboard. This skin will then be used as an insert in a traditional molding method of a dashboard skin (such as spraying, rotational molding, injection). Such a production in two parts makes it possible to limit the use of 3D printing to just the insert, in order to reduce the costs by only using the 3D printing method, which is more expensive, for one part of the skin and using a less expensive traditional method for the rest of the skin.

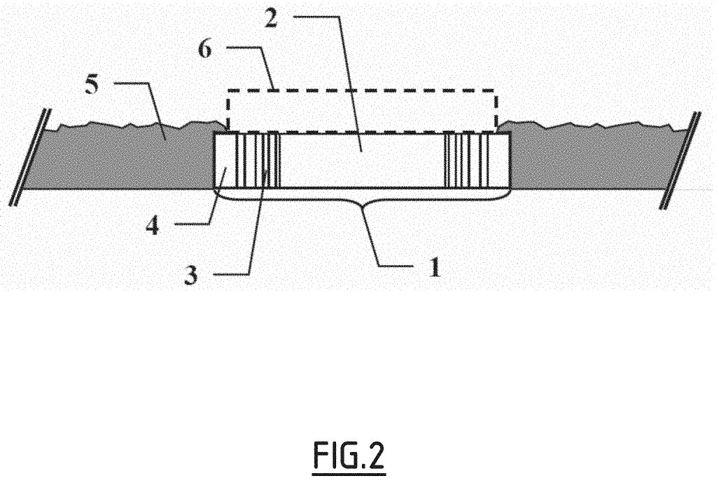

This is more specifically illustrated in FIG. 2. The central clear part 1 is the skin 1 made by 3D printing and the gray part 5 is made by a traditional process. The part 6, indicated in dotted lines, depicts a mask 6 used to protect the part 1 made by 3D printing during the traditional molding step.

Each of the first and/or second edges can have any shape. Such an edge can for example be curved or rectilinear. Advantageously, the edges follow the limits of the equipment item positioned below the skin 1. Thus, in the illustrative case of a rectangular screen, rectilinear edges, substantially parallel, are preferred.

One or more illustrative embodiments of the invention have been illustrated and described in detail in the drawings and the preceding description. The latter must be considered to be illustrative and provided as an example, and not as limiting the invention to this description alone. Many embodiment variants are possible.

1. A method for manufacturing a skin from a plastic material, wherein said method comprises the following steps:
producing a first part of the skin having a property according to a first level;
producing a second part of the skin extending the first part and having said property at the first level on a first edge in contact with the first part and a second level on a second edge in contact with a third part of the skin extending the second part; and
producing the third part of the skin having said at least one property at the second level, the production steps being carried out using additive technology.

2. The method according to claim 1, wherein said property evolves, in the second part, between the first edge and the second edge.

3. The method according to claim 1, wherein said property comprises the hardness, the color, the transparency and/or the surface state.

4. The method according to claim 1, wherein the production of the first part uses a first supply filament having the property at the first level, the production of the third part uses a second supply filament having the property at the second level and the production of the second part alternately uses the first supply filament and the second supply filament.

5. The method according to claim 4, wherein the alternation is produced by alternating a first head supplied with the first filament and a second head supplied with the second filament.

6. The method according to claim 1, applied to the production of a skin of a vehicle interior trim element.

7. The method according to claim 6, wherein the interior trim element is a dashboard.

8. The method according to claim 1, wherein the first part is rectangular, the second part is positioned on either side around the first part and the third part is positioned on either side around the second part.

9. The method according to claim 1, wherein the first part is rigid and transparent, the third part is flexible and opaque and the second part has a gradient of at least one of the two properties.

10. A skin made from plastic obtained by a method according to claim 1.
